(19) United States
(12) Patent Application Publication
(10) Pub. No.: US 2023/0291252 A1
(43) Pub. Date: Sep. 14, 2023

(54) INDUCTION MOTOR ROTOR AND INDUCTION MOTOR HAVING THE SAME

(71) Applicant: Jing-Jin Electric Technologies Co., Ltd., Beijing (CN)

(72) Inventors: Chun Tang, Farmington Hills, MI (US); Jingchuan Li, Farmington Hills, MI (US); Ping Yu, Beijing (CN); Haibin Wang, Beijing (CN)

(21) Appl. No.: 17/690,623

(22) Filed: Mar. 9, 2022

(51) Int. Cl. H02K 1/26

(52) U.S. Cl. CPC H02K 1/265

(57) ABSTRACT

The present disclosure discloses a rotor of an induction motor comprising a rotor body (1), alternating rotor teeth (2) and rotor slots (3) arranged along a circumference of the rotor body (1), and a plurality of grooves (4) provided at an end of the rotor teeth (2) or a plurality of voids (5) provided within the end of the rotor teeth (2) that are provided symmetrically about a center line (10) of the rotor teeth (2). The rotor and the induction motor having the rotor of the present disclosure can, for example, reduce the radial force of the stator caused by the slotting effect by about 50%. Therefore, the user's comfort can be greatly improved, while the efficiency of the induction motor can be improved, and the life of the induction motor can be prolonged.

### TECHNICAL FIELD

The present disclosure relates to a motor rotor and an induction motor having the same, in particular relates to a motor rotor capable of reducing NVH of an induction motor.

### BACKGROUND

Along with the development of the automobile industry, the NVH performance of vehicles has become a comprehensive technical index for quality evaluation of modem car manufacturing. NVH is the abbreviation of Noise, Vibration, Harshness. NVH influences the user experience of the vehicle users most directly and most significantly. The NVH problem of vehicles is one of the issues that gain the attention of large manufacturing enterprises of entire cars and component parts in the global car industry. Statistical data show that approximately ⅓ of the malfunctions of the entire car is related to the NVH problem of vehicles. The main energization sources that influence the magnitude of internal car noise include the components such as the engine, the electric motor, the reducer and the tire. Regarding electric vehicles, the main energization source is from the electric motor. A vehicle uses many electric motors, so the study on the noise and vibration of electric motors has become increasingly more important.

In the NVH of motor, the largest source of NVH is electromagnetic noise, which is mainly concentrated on the motor stator. The stator of the motor is affected by two parts of electromagnetic force, one is tangential force, which is mainly torque ripple. The other part is the radial force, which is greater than the tangential force. It is the main source of stator vibration and noise. Electromagnetic noise is caused by the magnetic tension that changes in time and space and acts between various parts of the motor. The electromagnetic noise of asynchronous motor is generated due to the following factors. First, there is a rotating force wave in the magnetic field in the air gap space, the radial force wave component of rotating force wave causes radial deformation and periodic vibration of stator and rotor, resulting in electromagnetic noise. Second, in the magnetic field in the air gap, in addition to the fundamental wave component of the power supply, there are also high-order harmonic components. The radial force waves of high-order harmonics also act on the stator and rotor core respectively, causing them to produce radial deformation and periodic vibration. In general, for high-order harmonics, the stiffness of the motor rotor is relatively strong, therefore the radial deformation of the stator core is the main part, which may produce large vibration, noise. Third, the deformation of different order harmonics of stator core has different natural frequencies. When the frequency of radial force wave is close to or equal to a natural frequency of core, it will cause “resonance”. In this case, even if the amplitude of radial force is small, it will lead to core's deformation, periodic vibration and large noise. Finally, after the stator is deformed, the surrounding air vibrates, resulting in noise. Therefore, it can be said that the force on the stator teeth, especially the radial force, is the main source of NVH.

There are various solutions to reduce NVH. For example, CN210404878U discloses a skewed-pole rotor of a motor, which effectively solves the technical problem of higher NVH of the motor in the prior art. The motor skewed-pole rotor comprises a shaft, an iron core is arranged on the shaft, the iron core comprises N iron core sections, N is larger than or equal to 2, a preset included angle θ is formed between magnetic poles of the adjacent iron core sections, and at least one key groove extending in the axial direction is formed in the shaft to accommodate the iron core sections. The key groove comprises a reference key groove, a rotary transformer installation groove is formed in one end of the shaft, and the reference key groove and the radial center line of the rotary transformer installation groove are in the same direction. Through the design of the skewed poles of the iron core in the rotor, the torque ripple can be effectively reduced, thereby reducing the vibration of the motor, the starting power consumption of the motor, and the NVH of the motor.

Although the skewed-pole rotor can be used to reduce the torque ripple, as described above, there are many reasons for the generation of radial force of the stator teeth, which is the main source of the motor NVH. Only reducing the torque ripple may not effectively reduce the radial force of the stator teeth. Especially in induction motors with rotor bars inserted in rotor slots, the skewed-pole rotor may not be applicable due to manufacturing constraints. In addition, the skewed-pole rotor of the motor also has the problem that the processing of the rotor becomes complicated and costly.

### SUMMARY

In view of the above problems in the prior art, the object of the present disclosure is to provide an induction motor rotor and an induction motor having the same, which can more efficiently reduce the NVH of the induction motor, especially the NVH of the induction motor with rotor bars inserted in rotor slots.

In order to achieve the above object, the present disclosure employs the following technical solutions:

According to an aspect of the present disclosure, there is provided a rotor of an induction motor, including a rotor body, alternating rotor teeth and rotor slots arranged along the circumference of the rotor body, grooves provided at the end of the rotor teeth or voids provided within the end of the rotor teeth, which is distributed symmetrically about the center line of rotor teeth.

Optionally, each two of the plurality of grooves or each two of the plurality of voids are provided on two rotor teeth whose center lines coincide.

Optionally, the groove or the void is provided on each rotor tooth.

Optionally, the shape of the groove is any one of semi-circle, semi ellipse, triangle, rectangle and trapezoid.

Optionally, the shape of the void is any one of semi-circle, semi ellipse, triangle, rectangle and trapezoid.

Optionally, at least a portion of the rotor teeth are connected to each other.

Optionally, the rotor slot adopts an opened-slot form.

In addition, there is provided an induction motor with the rotor of the induction motor described above.

In addition, there is provided a rotor lamination, including a lamination body, alternating rotor teeth and rotor groove arranged along the circumference of the rotor body, a groove provided at the end of the rotor tooth or a void provided within the end of the rotor tooth, which is distributed symmetrically about the center line of rotor tooth.

The advantageous effects of the present disclosure are as follows. The present disclosure solves the problems of prior art by placing grooves (notches) on the surface of the end of the rotor, or adding voids in the rotor teeth close to the rotor surface. It can reduce the harmonic flux caused by rotor slotting effect in the air gap, and hence reduce NVH in the order of rotor slot number.

### BRIEF DESCRIPTION OF THE DRAWINGS

FIG. 1 (a) is a top view of a rotor of an induction motor according to the first embodiment of the present disclosure;

FIG. 1 (b) is a schematic diagram of an induction motor according to the first embodiment of the present application, in which grooves are arranged on the outer peripheral surface of the rotor;

FIG. 2 is a diagram showing the shape of the grooves arranged on the rotor teeth of the present disclosure;

FIG. 3 (a) is a top view of the rotor of the induction motor according to the second embodiment of the present disclosure;

FIG. 3 (b) is a schematic diagram of adding the voids in the rotor teeth of the induction motor according to the second embodiment of the present disclosure;

FIG. 4 is a diagram showing the shape of the voids provided in the rotor teeth of the present disclosure;

FIG. 5 (a) is a comparison diagram showing the radial tooth force of the stator in prior art and the radial tooth force with the grooves arranged on the rotor of the induction motor in the present disclosure; and

FIG. 5 (b) is a comparison diagram showing the radial tooth force of the stator in prior art and the radial tooth force of the stator teeth when the void is provided in the rotor of the induction motor of the present disclosure.

In the drawings: 1: rotor body; 2: rotor tooth; 3: rotor slot; 4: groove; 5: void; 10: center line of rotor tooth.

### DETAILED DESCRIPTION

The induction motor in prior art generally adopts the tooth-slot structure. The teeth are used to guide the magnetic lines of force and reduce the magnetic reluctance. The slot is used to accommodate the winding and intersect with the magnetic lines of force in the teeth. The different magnetic conductivity of the teeth and slots makes the rotor have different numbers of magnetic lines of force at different positions. When the stator teeth align with the position of the rotor teeth, the magnetic field attract each other and hinder the rotation of the motor rotor, this is called slotting effect.

More specifically, due to the existence of the slots of the core, the inner circular surface of the core is undulating. For the magnetic pole, the magnetic reluctance of the air gap is actually changing. When the magnetic pole faces the tooth, the magnetic reluctance of the air gap becomes smaller, and when the magnetic pole faces the slot, magnetic reluctance becomes larger. With the rotation of the magnetic pole, the air gap magnetic reluctance changes continuously, resulting in the induction of potential in the stator winding. The potential induced in the winding due to the slotting effect is called tooth harmonic potential.

The radial force waves produced by these tooth harmonic potentials act on the stator and rotor cores respectively, resulting in radial deformation and periodic vibration. In general, high-order harmonics cause radial deformation of stator core, which will produce large vibration and noise.

In this case, in order to reduce the radial deformation of stator core, one possible way is rotor skewing. However, sometimes the rotor skewing may not effectively reduce the radial force on the stator teeth. In addition, especially in induction motor with rotor bars inserted in the rotor slots, the skewed-pole rotor may not be applicable due to manufacturing limitations.

In order to solve the above problems and reduce the NVH of induction motor more efficiently, the present disclosure provides a solution by providing grooves on the outer peripheral surface of the rotor or providing voids in the rotor teeth close to the rotor surface. Specifically, grooves are arranged symmetrically about the center line of the rotor teeth on the surface of the rotor, or voids are arranged symmetrically about the center line of rotor tooth inside the rotor teeth. In the case of rotor lamination, grooves are arranged symmetrically about the center line of rotor tooth on the outer peripheral surface of the lamination along the circumferential direction of the lamination, or voids are arranged symmetrically about the center line of rotor tooth inside the rotor teeth. Thus, the main harmonic component can be reduced.

More specifically, the groove or void itself will generate harmonics. When the harmonics generated by the groove or void change in phase with the harmonics generated by the stator, the torque ripple will increase; On the contrary, when the harmonic generated by the groove or void is different from that generated by the stator, the torque ripple will be reduced. In the process of rotation, the included angle between the center line of the rotor tooth of the rotor and the center line of the stator tooth of the stator will reduce the torque ripple. In addition, the harmonics generated by the groove or void will offset the harmful high-order harmonics of the original harmonic components. Moreover, the waveform of the higher harmonic of the original harmful harmonic component will be smoothed, so as to eliminate the harmful oscillation.

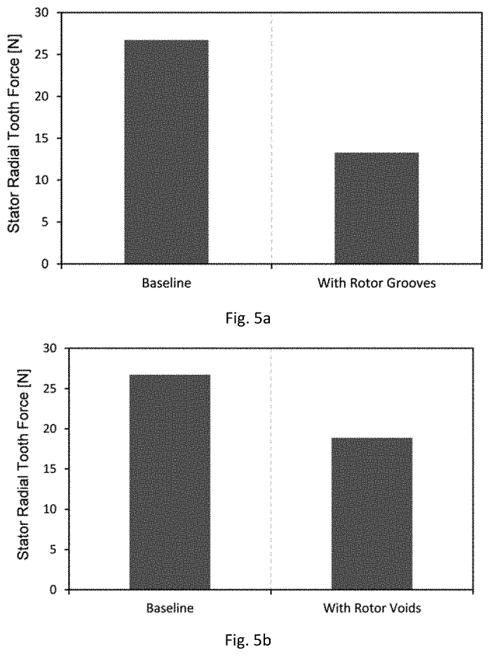

Specifically, the stator radial tooth force of an induction motor with rotor grooves and voids and the stator radial tooth force of an induction motor without rotor grooves and voids are compared in FIG. 5, where the “baseline” represents the design without applying grooves or voids. It can be seen from FIG. 5 that in the case of the rotor without grooves and voids, as shown by the baseline, due to the influence of high-order harmonics generated by harmonic flux caused by the slotting effect of the rotor in the air gap, the stator tooth generates a radial force of approximately 25-26 N. Accordingly, when the groove or void is symmetrically arranged about the center line of rotor tooth, the harmonic component is reduced through the groove or void, so that the radial force of the stator tooth is reduced to approximately 12-14 N. It can be seen that the radial force on the stator tooth can be greatly reduced by symmetrically added grooves or voids about the center line of rotor tooth. As explained above, since the force on the stator teeth, especially the radial force, is the main source of vibration and noise (NVH), the NVH of the induction motor is greatly reduced. Especially in induction motor with rotor bars inserted in rotor slots, the problem of large NVH of such induction motors can be solved when the skewed-pole rotor is not applicable due to manufacturing constraints.

In order to make the objectives, technical solutions and advantages of the present disclosure clearer, embodiments will be further described in detail below with reference to the accompanying drawings. Obviously, the described embodiments are part of the embodiments, rather than all of the embodiments of the present disclosure. All other embodiments obtained by those of ordinary skill in the art based on the described embodiments without paying creative work shall fall within the protection scope of the present disclosure.

### First Embodiment

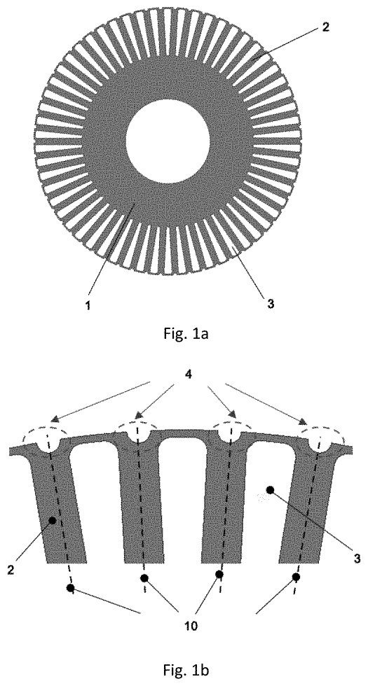

FIG. 1 (a) is a top view of a rotor of an induction motor according to the first embodiment of the present disclosure. As shown in FIG. 1, the present disclosure provides a rotor of an induction motor, including a rotor body 1, alternating rotor teeth 2 and rotor slots 3 arranged along the circumference of the rotor body 1, and grooves 4 symmetrically arranged about the center line 10 of rotor teeth 2. The grooves 4 are arranged on the outer surface of the rotor teeth 2, and the rotor slots 3 are used to accommodate the rotor bars.

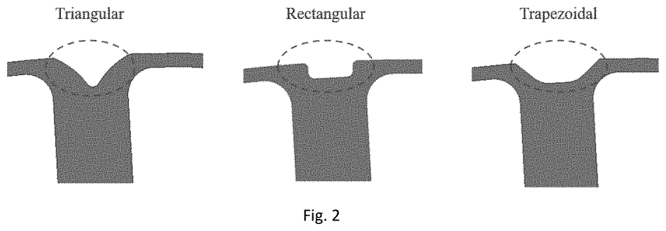

The groove 4 can be designed in various shapes. In addition to the semi-circle or semi-ellipse as shown in FIG. 1 (b), for example, it may be triangular, rectangular trapezoidal or other irregular shapes, as shown in FIG. 2. However, the shape of the groove 4 is symmetrical about the center line 10 of rotor tooth 2. For example, in the case of a circle, the diameter line of the circle coincides with the center line 10 of the rotor tooth 2, that is, the center line 10 of the rotor tooth 2 passes through the center of the circle. In the case of an ellipse, the major axis or minor axis of the ellipse coincides with the center line 10 of the rotor tooth 2. In the case of a triangle, it should be an isosceles triangle or an equilateral triangle. For example, in the case where the vertex angle forms an inverted triangle towards the center of the rotor body 1, the bisector of the vertex angle of the isosceles triangle coincides with the center line 10 of the rotor tooth 2, or the center line of the equilateral triangle coincides with the center line 10 of the rotor tooth 2.

During the operation of the induction motor, for example, in the motor operation mode, after the stator of the induction motor (not shown) on the periphery of the rotor is connected with the power supply, a rotating magnetic field is generated in the air gap between the stator and the rotor. The electromagnetic torque generated by electromagnetic induction acts on the rotor, and the rotor rotates under the action of electromagnetic torque, so as to output mechanical power outward. At this time, the induction motor inputs electric energy from the stator and outputs mechanical energy from the rotor, and the motor is in a running state.

However, when the rotor teeth 2 face the stator magnetic poles (stator windings) not shown, the air gap becomes relatively smaller and the magnetic reluctance becomes smaller. When the rotor slots 3 face the stator magnetic poles, the air gap becomes relatively larger, and the magnetic reluctance becomes larger, which is called the slotting effect. Through this slotting effect, a harmonic potential is induced in the stator bar. The radial force generated by the harmonic potential acts on the stator and the rotor to generate vibration and noise.

For example, when the rotor teeth 2 face the stator magnetic poles (not shown), the radial force F1 not shown toward the center of the rotor is generated on the stator due to the slotting effect as described above. However, in the case of the rotor provided with grooves 4 described above in the present disclosure, since the grooves 4 are provided on the rotor teeth 2, the air gap becomes relatively larger, resulting in a radial force F2 (not shown) opposite to the above radial force F1. Since the direction of the radial force F2 is opposite to the direction of the radial force F1, a part of the radial force F1 is offset, that is, the radial force F1 is reduced. As a result, vibration and noise caused by the radial force F1 are also reduced. Similarly, the grooves 4 can also reduce the radial force acting on the rotor teeth 2, thereby reducing the vibration and noise generated thereby.

In addition, in the generator operation mode of the induction motor, the rotor rotates in the opposite direction to the above motor operation mode, so that mechanical energy is input from the rotor and electrical energy is output from the stator. As in the motor operation mode, the groove 4 generates a radial force F2 in the opposite direction to the above radial force F1, offsets the radial force F1 generated by the stator, and similarly reduces the radial force on the stator.

In addition, since the groove 4 also reduces the harmonic potential generated by the slotting effect, it can also reduce the vibration and noise of the output electric energy.

Further, in the electromagnetic braking operation mode of the induction motor, the function of the grooves 4 is the same as in the above process, which is not repeated here.

According to the research and experiment of the inventors, as shown in FIG. 5, for example, the radial force of the stator can be reduced by about 50%. Since the radial force of stator teeth is the main source of NVH, the NVH caused by slotting effect can be reduced correspondingly by about 50%. In the induction motor installed with the rotor of the present disclosure and the electric vehicle installed with the induction motor, it can greatly improve the user's comfort, while improving the efficiency of the induction motor and prolonging the life of the induction motor.

In addition, since the radial force F2 generated by each groove 4 in the direction opposite to the radial force F1 of the stator will counteract the force on the corresponding stator teeth, it is preferable to provide the groove 4 on each rotor tooth 2. Thus, the radial force of the stator can be reduced correspondingly to the number of the grooves 4 (i.e. the number of the rotor teeth), that is, NVH can be reduced correspondingly. However, the number of grooves 4 can also be less than the number of rotor teeth 2, as long as the grooves 4 are configured to counteract the force on the stator teeth, that is, the grooves 4 are symmetrically arranged about the center line 10 of rotor teeth 2.

### Second Embodiment

This embodiment differs from the first embodiment in that a void 5 with the same function as the groove 4 is arranged inside the rotor tooth 2, that is, the void 5 is arranged inside the rotor tooth 2 and its position is close to the surface of the rotor tooth 2.

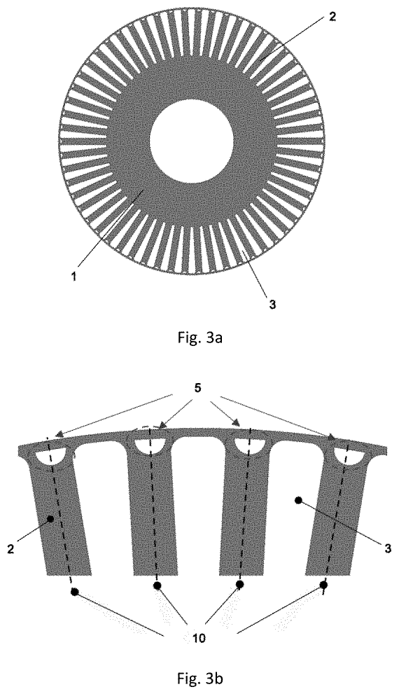

As shown in FIG. 3 (a), the void 5 is arranged inside the top of the rotor tooth 2 in a way of penetrating the rotor tooth 2. In this case, as described above, the void 5 can change the size of the air gap. Specifically, when the rotor teeth 2 are opposite to the stator magnetic poles (not shown), the air gap between the stator and the rotor becomes relatively smaller and the magnetic reluctance becomes smaller. However, due to the existence of the voids 5, a corresponding air gap is generated inside the rotor teeth 2, so that the overall air gap becomes larger and the overall change of the air gap is reduced. That is, contrary to the radial force F1 of the stator caused by the facing of the rotor teeth 2 and the stator magnetic poles, a radial force F2 opposite to the radial force F1 of the stator teeth is generated, because the air gap generated by the voids 5 becomes larger. The force F2, as described above, reduces the radial force applied to the stator teeth, thereby also reducing NVH.

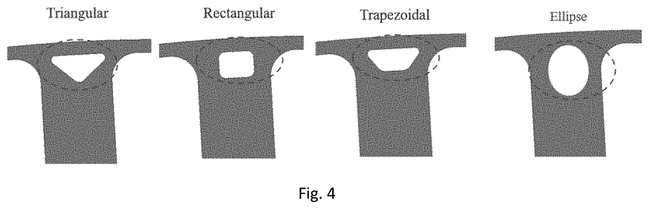

The shape of the void 5, besides the semicircle shown in FIG. 3 (b), may also be semi-ellipse (semi-cycle), triangle, rectangle, trapezoid, ellipse (or cycle) or an irregular shape, as shown in FIG. 4. These shapes play the same role.

In the rotor provided with the voids 5, as shown in FIG. 5 (b) which compares the radial force of the stator without voids and the radial force of the stator teeth with voids, the radial force of the stator teeth decreases from about 26-27N of the baseline to 17-18N on the right, and the radial force is roughly reduced by ⅓. Since the radial force on the stator teeth is the main source of NVH, about ⅓ of NVH caused by slotting effect can be reduced. It can also improve the user's comfort, improve the efficiency of induction motor and prolong the service life of induction motor.

In addition, the number of voids 5 is the same as the grooves 4 described above.

### Alternative Embodiments

The above briefly describes the structure and advantages of the rotor and induction motor of the present disclosure, but the rotor and induction motor of the present disclosure are not limited to the above embodiments, and there can be various alternative embodiments. For example, as shown in FIG. 1 (a) and FIG. 3 (a), the rotor slot 3 of the rotor of the present disclosure is a closed slot (that is, the rotor teeth 2 are connected with each other). The closed rotor slot 3 has large leakage reactance and small stray loss, which is conducive to reducing vibration and noise, starting current and slot torque. However, the starting torque and power factor will be reduced, especially the slot type of the rotor has a great impact on the starting performance. Therefore, the rotor of the present disclosure can also be applied to a rotor in the form of opened slot, that is, each rotor tooth 2 is not connected to each other, but an opening is formed at the position of the rotor slot 3. In this case, it is also possible to provide a groove 4 on the rotor tooth 2 or a void 5 inside the rotor tooth 2 as described above, and the same effect as that described above can be achieved.

Further, the structure of the rotor provided with grooves 4 or voids 5 of the present disclosure is described above. However, except cast-shaped integral rotors, the rotors are generally formed by stacking laminations made of silicon steel sheets. That is, the rotor of the present disclosure may be constructed by stacking a plurality of rotor laminations. Therefore, the grooves 4 or voids 5 described above can be provided on the rotor laminations. When stacking the rotor laminations for the rotor of the present disclosure, the grooves 4 or voids 5 provided can be aligned. If a groove 4 or a void 5 is provided on each rotor tooth 2, it is only necessary to align each rotor tooth 2.

The rotor provided with the grooves 4 or the voids 5 and the induction motor provided with the rotor of the present disclosure can, for example, reduce the radial force of the stator caused by the slotting effect by about 50%. Since the radial force of the stator teeth is the main source of vibration and noise (NVH), it can relatively reduce the NVH caused by slotting by about 50%. In products such as an induction motor equipped with the rotor of the present disclosure and an electric vehicle propelled by the induction motor, the user's comfort can be greatly improved, while the efficiency of the induction motor can be improved, and the life of the induction motor can be prolonged.

The above are merely particular embodiments of the present disclosure. By the teaching of the present disclosure, a person skilled in the art can make other modifications or variations on the basis of the above embodiments. A person skilled in the art should understand that the above particular descriptions are only for the purpose of better interpreting the present disclosure, and the protection scope of the present disclosure should be subject to the protection scope of the claims.

What is claimed is:

1. A rotor of an induction motor, comprising: a rotor body (1), alternating rotor teeth (2) and rotor slots (3) arranged along a circumference of the rotor body (1), and a plurality of grooves (4) provided at an end of the rotor teeth (2) or a plurality of voids (5) provided within the end of the rotor teeth (2) that are provided symmetrically about a center line (10) of the rotor teeth (2).

2. The rotor of an induction motor according to claim 1, wherein the number of the grooves (4) or voids (5) is less than the number of rotor teeth (2).

3. The rotor of an induction motor according to claim 1, wherein the groove (4) or the void (5) is provided on each rotor tooth (2).

4. The rotor of an induction motor according to claim 1, wherein the groove (4) is of a shape selected from semi-circle, semi ellipse, triangle, rectangle and trapezoid, or other irregular shapes.

5. The rotor of an induction motor according to claim 1, wherein the void (5) is of a shape selected from semi-circle, semi ellipse, triangle, rectangle and trapezoid, or other irregular shapes.

6. The rotor of an induction motor according to claim 4, wherein at least a portion of the rotor teeth (2) are connected to each other.

7. The rotor of an induction motor according to claim 5, wherein at least a portion of the rotor teeth (2) are connected to each other.

8. The rotor of an induction motor according to claim 1, wherein the rotor slot (3) is an opened slot.

9. An induction motor having a rotor of an induction motor, wherein the rotor of an induction motor comprises: a rotor body (1), alternating rotor teeth (2) and rotor slots (3) arranged along a circumference of the rotor body (1), and a plurality of grooves (4) provided at an end of the rotor teeth (2) or a plurality of voids (5) provided within the end of the rotor teeth (2) that are provided symmetrically about a center line (10) of the rotor teeth (2).

10. The rotor of an induction motor according to claim 9, wherein the number of the grooves (4) or voids (5) is less than the number of rotor teeth (2).

11. The rotor of an induction motor according to claim 9, wherein the groove (4) or the void (5) is provided on each rotor tooth (2).

12. The rotor of an induction motor according to claim 9, wherein the groove (4) is of a shape selected from semi-circle, semi ellipse, triangle, rectangle and trapezoid, or other irregular shapes.

13. The rotor of an induction motor according to claim 9, wherein the void (5) is of a shape selected from semi-circle, semi ellipse, triangle, rectangle and trapezoid, or other irregular shapes.

14. The rotor of an induction motor according to claim 12, wherein at least a portion of the rotor teeth (2) are connected to each other.

15. The rotor of an induction motor according to claim 13, wherein at least a portion of the rotor teeth (2) are connected to each other.

16. The rotor of an induction motor according to claim 9, wherein the rotor slot (3) is an opened slot.

17. A rotor lamination, comprising: a lamination body (1), alternating rotor teeth (2) and rotor slots (3) arranged along a circumference of the lamination body (1), and a plurality of grooves (4) provided at an end of the rotor teeth (2) or a plurality of voids (5) provided within the end of the rotor teeth (2) that are provided symmetrically about a center line (10) of the rotor teeth (2).
